(19) United States
(12) Patent Application Publication
(10) Pub. No.: US 2026/0061897 A1
(43) Pub. Date: Mar. 5, 2026

(54) SEAT OF VEHICLE

(71) Applicant: Hyundai Transys Inc., Seosan-si (KR)

(72) Inventors: Byung Min JEON, Hwaseong-si (KR); Cheon Ho KIM, Hwaseong-si (KR); Hyeon Je KIM, Hwaseong-si (KR)

(21) Appl. No.: 19/316,213

(22) Filed: Sep. 2, 2025

(30) Foreign Application Priority Data
Sep. 4, 2024 (KR) 10-2024-0120344

(51) Int. Cl. B60N 2/20; B60N 2/02; B60N 2/30; B60N 2/90

(52) U.S. Cl. CPC B60N 2/206; B60N 2/02246; B60N 2/3011; B60N 2/995; B60N 2002/924

(57) ABSTRACT

A vehicle seat includes a seat cushion frame; a seat back frame including an upper frame and a lower frame, wherein the upper frame is connected to the seat cushion frame at a first connection point and a second connection point, and the lower frame is connected to the seat cushion frame at a third connection point; and a plurality of actuators, each having an end portion connected to any one of the first connection point to the third connection point, and configured to implement movement of at least one of the upper frame or the lower frame by actuation.

### CROSS-REFERENCE TO THE RELATED APPLICATION

This application claims priority from Korean Patent Application No. 10-2024-0120344 filed on Sep. 4, 2024 in the Korean Intellectual Property Office, the disclosure of which is incorporated herein by reference in its entirety.

### FIELD OF DISCLOSURE

The present disclosure relates to a seat of a vehicle.

### BACKGROUND

With the development of autonomous driving technology, vehicles are being transformed to perform roles of various spaces. Vehicles can serve as office spaces for busy modern people, entertainment spaces that provide comfort for long-distance travel, or communication spaces where multiple people can face each other and communicate.

However, with the development of autonomous driving technology, there is a demand for increased freedom in seating direction within the vehicle. A representative example is a swivel-type rotation structure that rotates the seat. However, the swivel rotation structure has a limitation that there is interference with surrounding components when rotating the entire seat within a limited space. Therefore, the present disclosure aims to provide a seat of a vehicle that can be seated in both directions, overcoming the limitations of the driving radius caused by rotational movement.

The above matters disclosed in this section are merely for enhancement of understanding of the general background of the disclosure and should not be taken as an acknowledgement or any form of suggestion that the matters form the related art already known to a person skilled in the art.

### SUMMARY OF THE DISCLOSURE

Therefore, the present disclosure has been made in view of the above problems, and it is an object of the present disclosure to provide a seat of a vehicle that can be seated in both directions, overcoming the limitations of the driving radius caused by rotational movement.

The technical problems to be achieved by the present disclosure are not limited to the technical problems mentioned above, and other technical problems not mentioned can be clearly understood by those skilled in the art from the description below.

To accomplish the above object, a seat of a vehicle according to the present disclosure comprises a seat cushion frame; a seat back frame including an upper frame and a lower frame, the upper frame being connected to the seat cushion frame at a first connection point and a second connection point, the lower frame being connected to the seat cushion frame at a third connection point; and a plurality of actuators, each actuator having an end portion connected to one of the first connection point, the second connection point, and the third connection point, each actuator being configured to implement movement of at least one of the upper frame and the lower frame by actuation.

The upper frame may be connected to the first connection point by a first hinge and to the second connection point by a second hinge, the upper frame being configured to rotate around the first connection point or the second connection point. The lower frame may be connected to the third connection point by a third hinge and configured to rotate around the third connection point.

A motion space in which the lower frame is capable of rotating may be defined between lower end portions of the upper frame.

The seat cushion frame may include: a seat portion including a seat cushion; and a connecting portion to which the seat back frame is connected. The connecting portion may include a first bracket to which the upper frame is connected and a second bracket to which the lower frame is connected.

The first connection point and the second connection point may be positioned on the first bracket, the third connection point may be positioned on the second bracket, and the first connection point may be positioned higher than the second connection point.

The plurality of actuators may comprise a first drive motor having an end portion connected to the first connection point, the first drive motor being configured to move the upper frame; a second drive motor having an end portion connected to the second connection point, the second drive motor being configured to move the upper frame; and a third drive motor having an end portion connected to the third connection point, the third drive motor being configured to move the lower frame.

The seat cushion frame may include a connecting portion to which the seat back frame is connected, wherein the connecting portion may include a first bracket to which the upper frame is connected and a second bracket to which the lower frame is connected, and wherein the first drive motor and the second drive motor may be connected to the first bracket, and the third drive motor may be connected to the second bracket.

An end portion of the first drive motor may be connected to the upper frame at the first connection point by a first shaft, an end portion of the second drive motor may be connected to the upper frame at the second connection point by a second shaft, and an end portion of the third drive motor may be connected to the lower frame at the third connection point by a third shaft.

The first connection point may be positioned higher than the second connection point, and the second drive motor may be configured to be driven together with the third drive motor to rotate the upper frame and the lower frame in a same direction, thereby implementing a reclining movement of the seat back frame.

A motion space in which the lower frame is capable of rotating may be defined between lower end portions of the upper frame, and the first drive motor and the third drive motor may be configured to rotate the upper frame and the lower frame, respectively, in different directions from each other to provide a face-to-face seating mode.

The third drive motor may be configured to be driven to rotate the lower frame toward a rear seat to provide a leg rest mode.

The third connection point may be positioned rearward of the first connection point and the second connection point.

The first shaft, the second shaft, and the third shaft may extend in parallel to one another.

The third connection point may be positioned at a distal end of the second bracket.

The motion space may extend to a lowermost end of the upper frame.

The first connection point may be positioned at a distal end of the first bracket, and the second connection point may be positioned at another end of the first bracket opposite to the distal end of the first bracket.

The upper frame may include a first seat back cushion, and the lower frame may include a second seat back cushion, the first seat back cushion and the second seat back cushion being separate from each other.

The second seat back cushion may be configured to indent or protrude through the motion space compared to the first seat back cushion in a reclining mode.

When viewed from a side of the vehicle seat, the connecting portion may extend from the seat portion at a predetermined angle relative to the seat portion, and the first bracket may extend at another predetermined angle relative to the second bracket.

The third drive motor may be disposed inside the lower frame and configured to rotate together with the lower frame around a rotating axis of the lower frame.

According to the seat of a vehicle of the present disclosure, a face-to-face seating mode, a leg rest mode, or a reclining mode can be implemented according to various movements of the seat back frame in a general occupant seating mode.

The effects obtainable from the present disclosure are not limited to the effects mentioned above, and other effects not mentioned can be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings.

FIG. 1 shows a front portion of a seat of a vehicle according to an embodiment of the present disclosure.

FIG. 2 shows a rear portion of a seat of a vehicle according to an embodiment of the present disclosure.

FIGS. 3 to 5 show side views of the seat according to various vehicle seat modes. FIG. 3 shows a leg rest mode. FIG. 4 shows a face-to-face seating mode. FIG. 5 shows a reclining mode.

FIGS. 6 to 8 are enlarged views of each actuator for explaining the plurality of actuators.

### DETAILED DESCRIPTION OF THE PREFERRED EMBODIMENTS

Hereinafter, embodiments disclosed in the present specification will be described in detail with reference to the accompanying drawings. In describing embodiments disclosed in the present specification, detailed descriptions of related known technologies will be omitted when it is determined that they may obscure the essence of the embodiments disclosed in the present specification. Additionally, the accompanying drawings are merely for easy understanding of the embodiments disclosed in the present specification, and it should be understood that the technical ideas disclosed in the present specification are not limited by the accompanying drawings and include all changes, equivalents, and substitutes included in the spirit and technical scope of the present disclosure.

Terms including ordinal numbers such as first and second may be used to describe various components, but the components are not limited by the terms. The terms are used only for the purpose of distinguishing one component from another component.

Singular expressions include plural expressions unless the context clearly indicates otherwise.

In the present specification, terms such as “comprise” or “have” are intended to designate that features, numbers, steps, operations, components, parts, or combinations thereof described in the specification exist, and should be understood as not excluding in advance the existence or addition possibility of one or more other features, numbers, steps, operations, components, parts, or combinations thereof.

The suffixes “module” and “unit” for components used in the following description are given or used interchangeably considering only the ease of specification writing, and do not have meanings or roles that are distinct from each other.

When it is mentioned that a component is “connected” or “connected” to another component, it should be understood that it may be directly connected or connected to the other component, but other components may exist in between. On the other hand, when it is mentioned that a component is “directly connected” or “directly connected” to another component, it should be understood that no other component exists in between.

A controller may include a communication device that communicates with other controllers or sensors for control of responsible functions, a memory that stores operating systems, logic commands, input/output information, etc., and one or more processors that perform judgments, calculations, decisions, etc. necessary for responsible function control.

Hereinafter, embodiments disclosed in the present specification will be described in detail with reference to the accompanying drawings, and the same or similar components will be given the same reference numbers regardless of the figure numbers, and redundant descriptions thereof will be omitted.

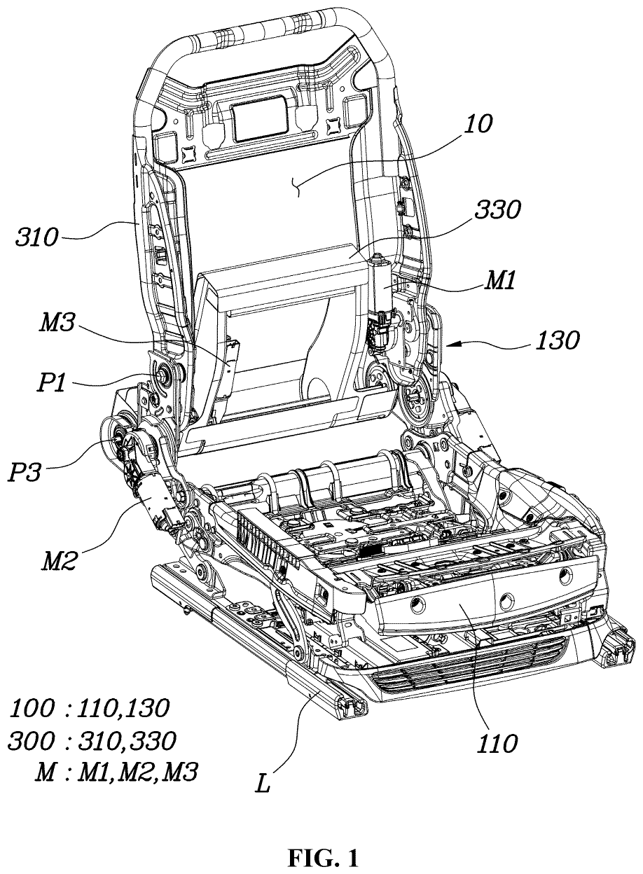

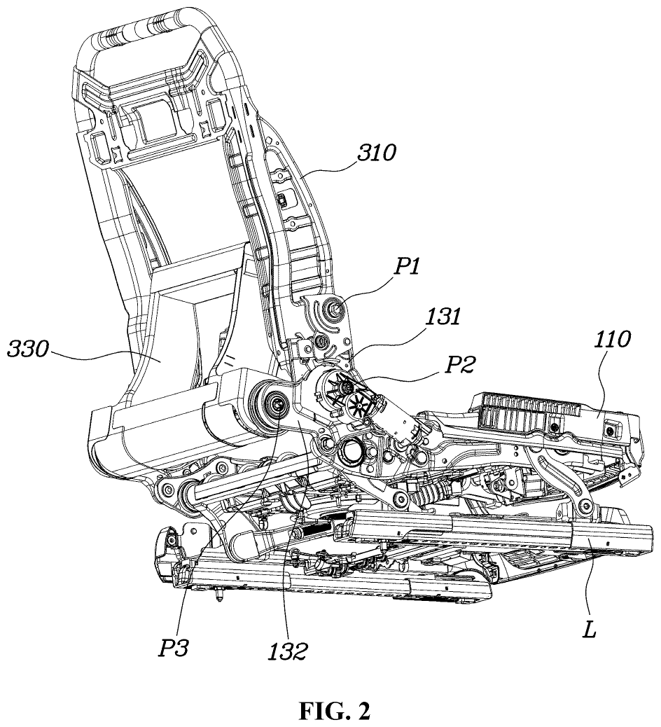

FIG. 1 shows a front portion of a seat of a vehicle according to an embodiment of the present disclosure. FIG. 2 shows a rear portion of a seat of a vehicle according to an embodiment of the present disclosure. FIGS. 1 and 2 show a state of the vehicle seat in a basic driving mode, and it is assumed that, in other modes (face-to-face seating mode, leg rest mode) to be described later, movement of the seat back frame is performed from the driving mode shown in FIGS. 1 and 2.

Referring to FIGS. 1 and 2, a seat of a vehicle according to an embodiment of the present disclosure comprises a seat cushion frame 100; a seat back frame 300 including an upper frame 310 and a lower frame 330, wherein the upper frame 310 is connected to the seat cushion frame 100 at a first connection point P1 and a second connection point P2, and the lower frame 330 is connected to the seat cushion frame 100 at a third connection point P3; and a plurality of actuators M, each having an end portion connected to any one of the first connection point P1, the second connection point P2, and the third connection point P3, and configured to implement movement of at least one of the upper frame 310 or the lower frame 330 by actuation. The seat cushion frame 100 is formed with a seat portion 110 at which a seat cushion for an occupant to be seated is formed and a connecting portion 130 to which the seat back frame 300 is connected. A floor rail L for moving the seat in a front-rear direction may be provided at a lower portion of the seat cushion frame 100.

The seat back frame 300 is formed with a seat back cushion against which an occupant's back can lean when the occupant is seated. According to an embodiment of the present disclosure, the seat back frame 300 is divided into two parts. One is the upper frame 310, and another is the lower frame 330. The upper frame 310 can support an upper portion of an occupant's upper body when the occupant is seated, and the lower frame 330 can support a lower portion of the occupant's upper body. The upper frame 310 and the lower frame 330 can each move independently or move in coordination with each other by a plurality of actuators M to be described later, and various modes of the seat can be implemented by independent and coordinated movements of the upper frame 310 and the lower frame 330. In particular, the upper frame 310 has a space formed between both lower end portions of the upper frame 310 connected to the seat cushion frame 100, and the lower frame 330 is provided in the space. That is, the lower frame 330 is provided between the upper frames 310, and the space where the lower frame 330 is provided between the upper frames 310 is referred to as a motion space 10. The lower frame 330 is capable of rotating within the motion space 10 by the plurality of actuators M. To allow free movement of the lower frame 330 without being constrained by the upper frame 310, seat back cushions formed on the lower frame 330 and the upper frame 310 are separated from each other.

Meanwhile, the upper frame 310 is connected to the seat cushion frame 100 at the first connection point P1 and the second connection point P2. The upper frame 310 is hingedly connected at the first connection point P1 and the second connection point P2 and can be rotated around the first connection point P1 or the second connection point P2, that is, around the seat cushion frame 100.

The lower frame 330 is connected to the seat cushion frame 100 at the third connection point P3. The lower frame 330 is also hingedly connected at the third connection point P3 and can be rotated around the third connection point P3.

The plurality of actuators M may be provided at the seat cushion frame 100. Each end portion of the plurality of actuators M provided at the seat cushion frame 100 may be connected to any one of the first connection point P1, the second connection point P2, and the third connection point P3, and when any one of the plurality of actuators M is driven, movement of any one of the upper frame 310 or the lower frame 330 can be implemented.

That is, when an actuator connected to the first connection point P1 is driven, movement in which the upper frame 310 rotates around the first connection point P1 is implemented. When an actuator connected to the second connection point P2 is driven, movement in which the upper frame 310 rotates around the second connection point P2 is implemented. When an actuator connected to the third connection point P3 is driven, movement in which the lower frame 330 rotates around the third connection point P3 is implemented.

Only one of the plurality of actuators M may be driven to implement rotation of the upper frame 310 or the lower frame 330, but of course, two or more of the plurality of actuators M may be driven to implement coordinated movement of the upper frame 310 and the lower frame 330.

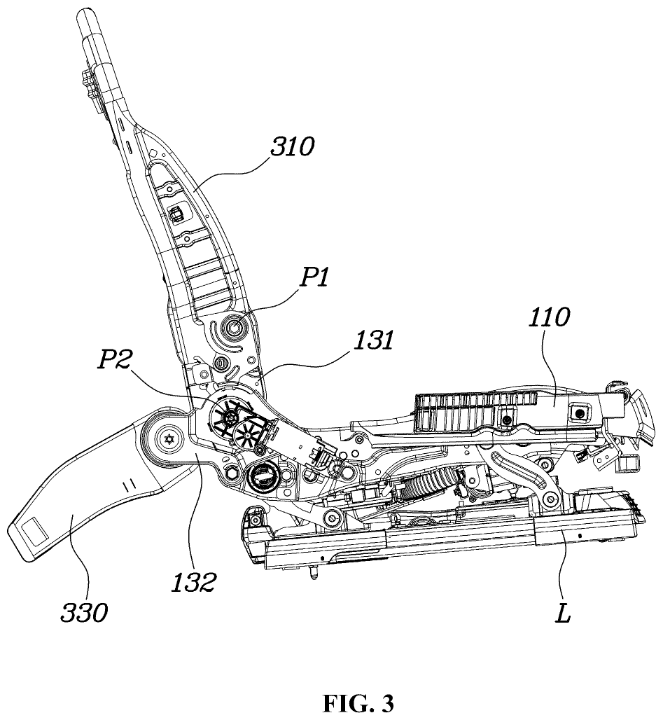

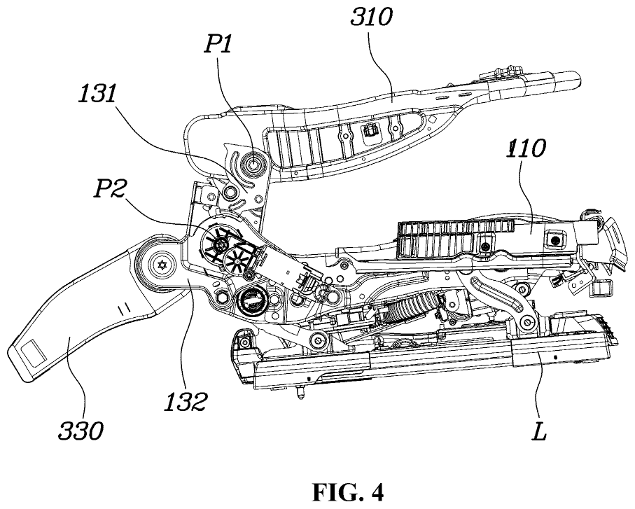

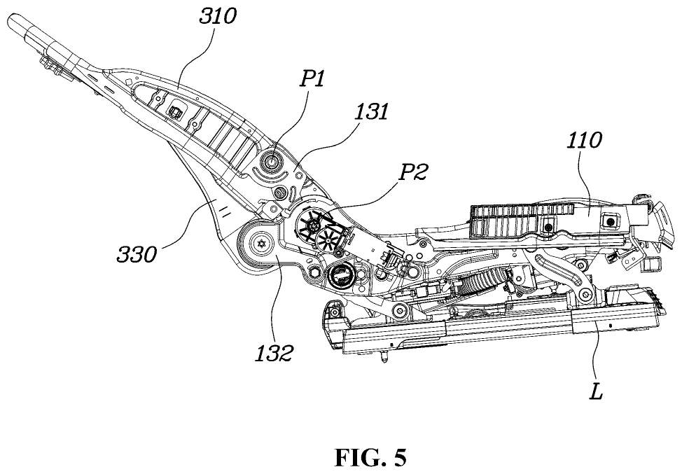

FIGS. 3 to 5 show side views of the seat according to various vehicle seat modes. FIG. 3 shows a leg rest mode. FIG. 4 shows a face-to-face seating mode. FIG. 5 shows a reclining mode. Specifically, when an actuator connected to the third connection point P3 is driven, the lower frame 330 rotates around the third connection point P3, so that it can perform a role of a leg rest on which an occupant positioned at a rear side can place feet.

When an actuator connected to the first connection point P1 is driven so that the upper frame 310 rotates toward the seat cushion frame 100 side, and an actuator connected to the third connection point P3 is driven so that the lower frame 330 rotates in an opposite direction to the upper frame 310, the seat can become a seat that can be seated to face each other with an occupant sitting in a rear seat. That is, the seat cushion is exposed through the motion space 10 formed in the upper frame 310 and an occupant can be seated on the seat cushion, the folded upper frame 310 can support the occupant's back or neck, and the lower frame 330 conversely performs a role of a leg rest for the occupant seated in the seat cushion in a direction opposite to the rear seat to face the occupant sitting in the rear seat.

Additionally, when an actuator connected to the second connection point P2 and an actuator connected to the third connection point P3 are driven, the upper frame 310 rotates based on the second connection point P2, and the lower frame 330 rotates based on the third connection point P3, thereby enabling a reclining mode of the seat back frame.

Meanwhile, the connecting portion 130 of the seat cushion frame 100 may include a first bracket 131 to which the upper frame 310 is connected and a second bracket 132 to which the lower frame 330 is connected. The first bracket 131 and the second bracket 132 are configured as separate components. The first connection point P1 and the second connection point P2 are positioned on the first bracket 131 to which the upper frame 310 is connected, and the third connection point P3 is positioned on the second bracket 132 to which the lower frame 330 is connected. More specifically, the first connection point P1 is positioned higher than the second connection point P2, and the third connection point P3 may be positioned rearward of the first connection point P1 and the second connection point P2. This is to position the first connection point P1 higher than the second connection point P2 so that the upper frame 310 can stably support an occupant's upper body in the face-to-face seating mode, and in the reclining mode, without interfering with the first connection point P1, the upper frame 310 can be rotated based on the second connection point P2 so that the reclining mode can be performed naturally.

The second bracket 132 to which the lower frame 330 is connected is provided to be fixed on the seat cushion frame 100. On the other hand, the first bracket 131 to which the upper frame 310 is connected is provided to be rotatable around the seat cushion frame 100. That is, the first bracket 131 is hingedly connected to the seat cushion frame 100, and when implementing the reclining mode, the first bracket 131 rotates and the inclination of the upper frame 310 is changed. At this time, simultaneously, the lower frame 330 also rotates so that the reclining mode can be implemented.

Meanwhile, the plurality of actuators M comprise a first drive motor M1, a second drive motor M2, and a third drive motor M3. The first drive motor M1 has an end portion connected to the first connection point P1 and implements movement of the upper frame 310. The second drive motor M2 has an end portion connected to the second connection point P2 and implements movement of the upper frame 310. The third drive motor M3 has an end portion connected to the third connection point P3 and implements movement of the lower frame 330. In other words, the first drive motor M1 and the third drive motor M3 can be coordinated to implement the face-to-face seating mode, the second drive motor M2 and the third drive motor M3 can be coordinated to implement the reclining mode, and the third drive motor M3 can be operated to implement the leg rest mode.

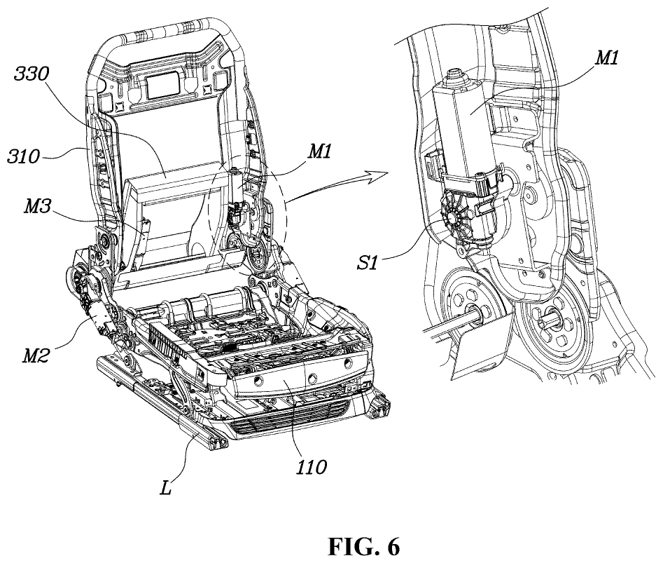

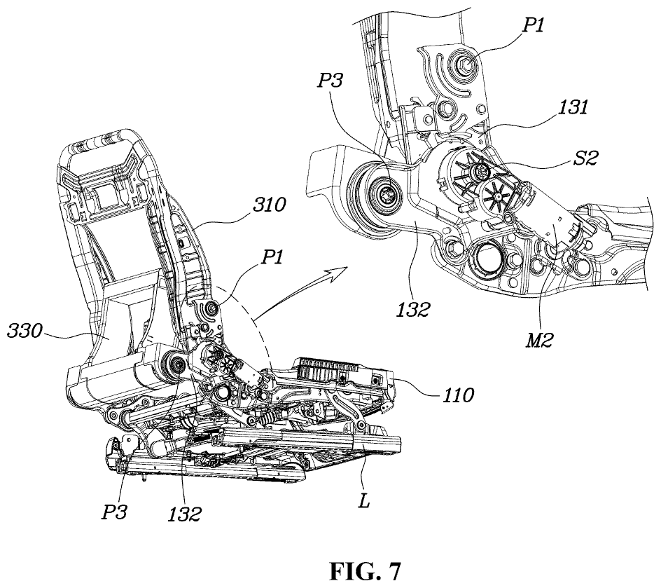

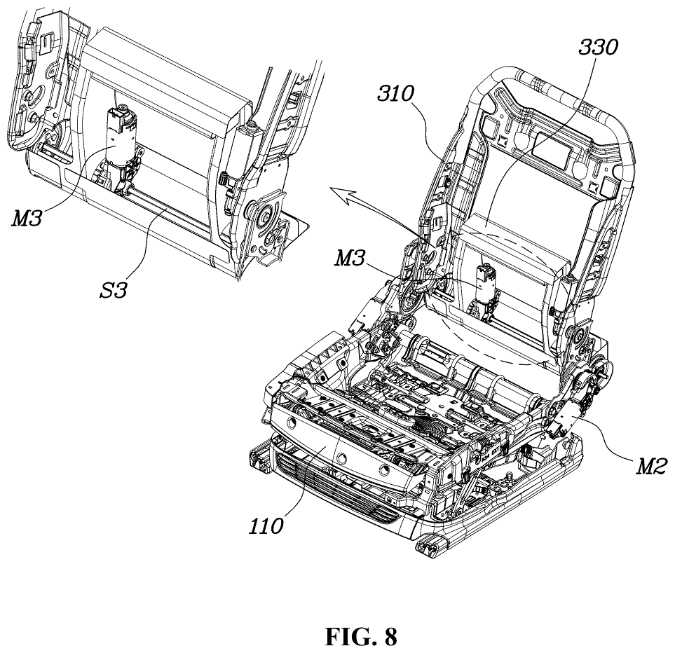

More specifically, referring to FIGS. 6 to 8, an end portion of the first drive motor M1 is connected to the upper frame 310 at the first connection point P1 of the first bracket 131 through a first shaft S1. An end portion of the second drive motor M2 is connected to the upper frame 310 at the second connection point P2 of the first bracket 131 through a second shaft S2. An end portion of the third drive motor M3 is connected to the lower frame 330 at the third connection point P3 of the second bracket 132 through a third shaft S3.

Describing modes implemented according to such configuration, the second drive motor M2 may be driven together with the third drive motor M3 to rotate the upper frame 310 and the lower frame 330 in a same direction, thereby implementing a reclining movement of the seat back frame 300. The second drive motor M2 and the third drive motor M3 can be driven simultaneously to implement the reclining movement, and the second drive motor M2 can be driven first to adjust the inclination of the upper frame 310, and the third drive motor M3 can be driven thereafter to adjust the inclination of the lower frame 330. Through this, an occupant can make the seat back cushion formed on the lower frame 330 protrude or indent compared to the seat back cushion formed on the upper frame 310, and can adjust a reclining angle suitable for the occupant's body type.

Additionally, the third drive motor M3 may be driven to rotate the lower frame 330 toward a rear seat, thereby implementing a leg rest mode, and the first drive motor M1 and the third drive motor M3 may be driven to rotate the upper frame 310 and the lower frame 330 in different directions from each other, thereby implementing a face-to-face seating mode.

The seat of a vehicle according to an embodiment of the present disclosure may further comprise a controller for controlling actuation of the first drive motor M1, the second drive motor M2, and the third drive motor M3. A controller for controlling movement of the seat back frame 300 or the seat cushion frame 100 may be provided on a side of the seat back frame 300 or the seat cushion frame 100. To enable a passenger positioned in a rear seat to also control a front seat, it is preferable to provide the controller as a remote control type, but it is also acceptable to provide it as a switch type.

According to the seat of a vehicle according to the present disclosure, there is an advantage that a seat of a vehicle that can be seated in both directions can be provided by adjusting inclinations of the seat back frame divided into an upper frame and a lower frame without a separate swivel device, and there is additionally an advantage that various modes can be provided by adjusting angles of the upper frame and the lower frame.

Although specific embodiments related to the present disclosure have been illustrated and described, it will be apparent to those skilled in the art that various improvements and changes can be made within the scope of the technical idea of the present disclosure provided by the following claims without departing from the technical idea of the present disclosure.

What is claimed is:

1. A vehicle seat comprising:
a seat cushion frame;
a seat back frame including an upper frame and a lower frame, the upper frame being connected to the seat cushion frame at a first connection point and a second connection point, the lower frame being connected to the seat cushion frame at a third connection point; and
a plurality of actuators, each actuator having an end portion connected to one of the first connection point, the second connection point, and the third connection point, each actuator being configured to move at least one of the upper frame and the lower frame.

2. The vehicle seat according to claim 1,
wherein the upper frame is connected to the first connection point by a first hinge and to the second connection point by a second hinge, the upper frame being configured to rotate around the first connection point or the second connection point,
wherein the lower frame is connected to the third connection point by a third hinge and configured to rotate around the third connection point.

3. The vehicle seat according to claim 1, wherein a motion space in which the lower frame is capable of rotating is defined between lower end portions of the upper frame.

4. The vehicle seat according to claim 1, wherein the seat cushion frame includes:
a seat portion including a seat cushion; and
a connecting portion to which the seat back frame is connected, the connecting portion including a first bracket to which the upper frame is connected and a second bracket to which the lower frame is connected.

5. The vehicle seat according to claim 4, wherein the first connection point and the second connection point are positioned on the first bracket, the third connection point is positioned on the second bracket, and the first connection point is positioned higher than the second connection point.

6. The vehicle seat according to claim 1, wherein the plurality of actuators comprises:
a first drive motor having an end portion connected to the first connection point, the first drive motor being configured to move the upper frame;
a second drive motor having an end portion connected to the second connection point, the second drive motor being configured to move the upper frame; and
a third drive motor having an end portion connected to the third connection point, the third drive motor being configured to move the lower frame.

7. The vehicle seat according to claim 6,
wherein the seat cushion frame includes a connecting portion to which the seat back frame is connected,
wherein the connecting portion includes a first bracket to which the upper frame is connected and a second bracket to which the lower frame is connected, and
wherein the first drive motor and the second drive motor are connected to the first bracket, and the third drive motor is connected to the second bracket.

8. The vehicle seat according to claim 6, wherein an end portion of the first drive motor is connected to the upper frame at the first connection point by a first shaft, an end portion of the second drive motor is connected to the upper frame at the second connection point by a second shaft, and an end portion of the third drive motor is connected to the lower frame at the third connection point by a third shaft.

9. The vehicle seat according to claim 6, wherein the first connection point is positioned higher than the second connection point, and the second drive motor is configured to be driven together with the third drive motor to rotate the upper frame and the lower frame in a same direction to provide a reclining movement of the seat back frame.

10. The vehicle seat according to claim 6, wherein a motion space in which the lower frame is capable of rotating is defined between lower end portions of the upper frame, and the first drive motor and the third drive motor are configured to rotate the upper frame and the lower frame, respectively, in different directions from each other to provide a face-to-face seating mode.

11. The vehicle seat according to claim 6, wherein the third drive motor is configured to be driven to rotate the lower frame toward a rear seat to provide a leg rest mode.

12. The vehicle seat according to claim 5, wherein the third connection point is positioned rearward of the first connection point and the second connection point.

13. The vehicle seat according to claim 8, wherein the first shaft, the second shaft, and the third shaft extend in parallel to one another.

14. The vehicle seat according to claim 5, wherein the third connection point is positioned at a distal end of the second bracket.

15. The vehicle seat according to claim 3, wherein the motion space extends to a lowermost end of the upper frame.

16. The vehicle seat according to claim 5, wherein the first connection point is positioned at a distal end of the first bracket, and the second connection point is positioned at another end of the first bracket opposite to the distal end of the first bracket.

17. The vehicle seat according to claim 3, wherein the upper frame includes a first seat back cushion, and the lower frame includes a second seat back cushion, the first seat back cushion and the second seat back cushion being separate from each other.

18. The vehicle seat according to claim 17, wherein the second seat back cushion is configured to indent or protrude through the motion space compared to the first seat back cushion in a reclining mode.

19. The vehicle seat according to claim 4, wherein, when viewed from a side of the vehicle seat, the connecting portion extends from the seat portion at a predetermined angle relative to the seat portion, and the first bracket extends at another predetermined angle relative to the second bracket.

20. The vehicle seat according to claim 6, wherein the third drive motor is disposed inside the lower frame and configured to rotate together with the lower frame around a rotating axis of the lower frame.
